(19) United States
(12) Patent Application Publication
(10) Pub. No.: US 2026/0046755 A1
(43) Pub. Date: Feb. 12, 2026

(54) ALLOCATING NETWORK SLICES TO AN AIRBORNE USER EQUIPMENT

(71) Applicant: T-MOBILE INNOVATIONS JLLC, Overland Park, KS (US)

(72) Inventors: Bhagwan Singh KHANKA, Las Vegas, NV (US); Brandon James BRAUNLICH, Henderson, NV (US)

(21) Appl. No.: 18/799,811

(22) Filed: Aug. 9, 2024

(51) Int. Cl. H04W 48/18; H04W 4/14; H04W 84/06

(52) U.S. Cl. CPC H04W 48/18; H04W 4/14; H04W 84/06

(57) ABSTRACT

Embodiments of the present disclosure are directed to systems and methods for allocating different network slices to airborne frequency bands. More particularly, in aspects set forth herein, systems and methods are directed to a network slicing paradigm that could be used to enable the provision of service to UEs in the air. By creating virtual partitions in the network, network slicing allows mobile operators to customize treatment for specific traffic flows or applications, including those from airborne UEs. This enables tailored services, such as prioritizing low-latency connections for critical flight communications or allocating enhanced resources for data-intensive applications, thereby optimizing connectivity and performance for airborne UEs.

### SUMMARY

The present disclosure is directed to improving the telecommunications service of an airborne user equipment (UE), substantially as shown and/or described in connection with at least one of the Figures, and as set forth more completely in the claims.

According to various aspects of the technology, dynamic network slicing is utilized to enable and disable a dedicated slice for a user. In some instances, a user equipment (UE) may be assigned to a particular network slice in order to effectuate a certain allocation of network resources to the UE, such as when the UE is accessing or utilizing a particular application or service. The network slice may be based on a minimum quality of service (QoS) needed for the UE to effectively access or use said application or service. This is the same whether a UE is terrestrial or airborne. For example, once the UE is considered airborne and has connected to an airborne frequency, the airborne frequency band might provide the same service options to the user as a terrestrial frequency band does on the ground (e.g., voice, SMS, data, video streaming, etc.). An airborne UE may not want or need all of the same service options as it has on the ground. By allocating different network slices to the airborne frequency bands, mobile network operators can provide a better user experience for those on aircraft and better control the provision of mobile service.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an exemplary computing device for use with the present disclosure;

FIG. 2 depicts a diagram of an exemplary network environment in which implementations of the present disclosure may be employed, in accordance with aspects herein;

FIG. 3 depicts dynamic network slicing in a network, in which implementations of the present disclosure may be employed, in accordance with aspects herein; and

FIG. 4 is a flow diagram of a method for dynamically allocating network resources to devices in a network, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Computer-readable media do not include purely transitory signals. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, network slicing is an architectural paradigm in telecommunication networks wherein network resources are logically partitioned into multiple virtual networks, or “slices,” each catering to distinct service requirements. Network slicing allows for the allocation and isolation of resources such as computing, storage, and bandwidth and can be customized with specific Quality of Service (QoS) characteristics, latency profiles, and security parameters to meet the unique demands of diverse applications, services, or user groups. Using network slicing, mobile network operators can efficiently share a common network infrastructure while accommodating the different needs of services including ultra-reliable low-latency communication (URLLC) and enhanced mobile broadband (eMBB). Allocating network slices to airborne frequency bands presents a complex challenge in establishing reliable connections with terrestrial networks. Airborne UEs, including drones or UEs on airplanes, require seamless connectivity to cell towers similar to terrestrial users. However, maintaining stable connections, especially at higher altitudes, proves challenging. While telecommunication signals may be accessible at lower altitudes, typically below 10,000 feet during takeoff and landing, service availability is restricted to critical phases of flight. The limited duration spent at these altitudes further complicates the issue, emphasizing the need for efficient network slice allocation strategies tailored to airborne scenarios.

Conventionally, airborne UEs connected to base stations are indistinguishable from terrestrial UEs, in terms of available service. If an airborne UE happens to be located in a terrestrial cell (which typically only happens today at very low altitudes or in a tropospheric duct), it would receive similar services as terrestrial UEs, encompassing voice calls, SMS, video streaming, and data services. Yet, reliability and quality often diminish at higher altitudes due to weaker signals and limited coverage areas. Moreover, the continuous usage of multiple communication services, particularly data-intensive ones like video streaming by a large number of users in a small area can cause service or capacity challenges for a network operator.

Unlike conventional solutions, the present disclosure is directed to a network slicing paradigm that could be used to enable the provision of service to UEs in the air. By creating virtual partitions in the network, network slicing allows mobile operators to customize treatment for specific traffic flows or applications, including those from airborne UEs. This enables tailored services, such as prioritizing low-latency connections for critical flight communications or allocating enhanced resources for data-intensive applications, thereby optimizing connectivity and performance for airborne UEs while minimizing power consumption. For example, some limitations of service might be desirable for UEs in a plane (e.g., provide voice and SMS but not data, provide everything but voice, everything but video streaming, etc.). Additionally, a multi-tier subscription model could be used wherein each tier can be allocated a unique network slice with unique capabilities. This would improve the reliability and efficiency of cellular connectivity for airborne UEs.

Accordingly, a first aspect of the present disclosure is directed to a method for allocating network slices to a user equipment (UE), the method comprises determining that a UE is airborne during a first time period and allocating a first network slice to the UE during the first time period. The method also comprises determining that the UE is not airborne at a conclusion of the first time period and terminating the allocation of the first network slice to the UE at the conclusion of the first time period.

A second aspect of the present disclosure is directed to a system for allocating network slices to a user equipment (UE), the system comprises one or more processors and one or more computer-readable media storing computer-usable instructions that, when executed by the one or more processors, cause the one or more processors to determine that a UE is airborne during a first time period and allocate a first network slice to the UE during the first time period. The system also determines that the UE is not airborne at a conclusion of the first time period and then terminates the allocation of the first network slice to the UE at the conclusion of the first time period.

Another aspect of the present disclosure is directed to one or more non-transitory computer-readable media having computer-usable instructions embodied thereon that, when executed by one or more processors, cause the processors to determine that a UE is airborne during a first time period and allocate a first network slice to the UE during the first time period. The system also determines that the UE is not airborne at a conclusion of the first time period and then terminates the allocation of the first network slice to the UE at the conclusion of the first time period.

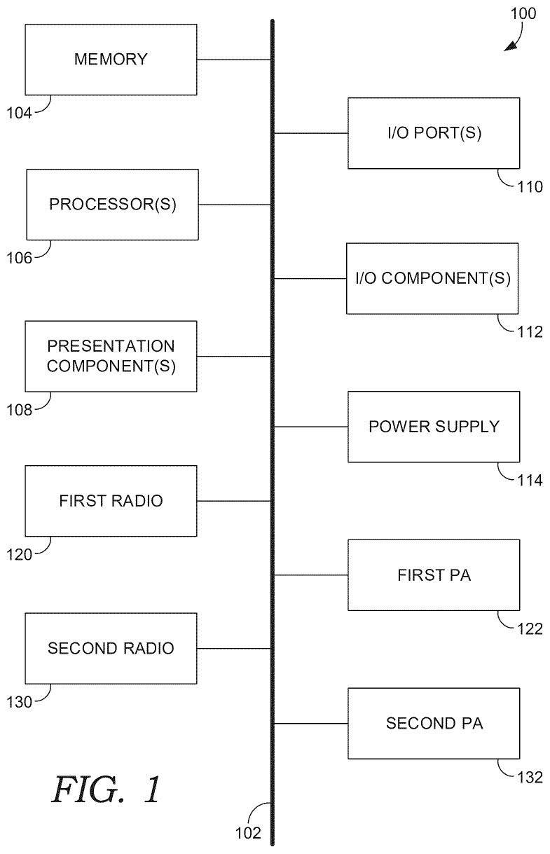

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

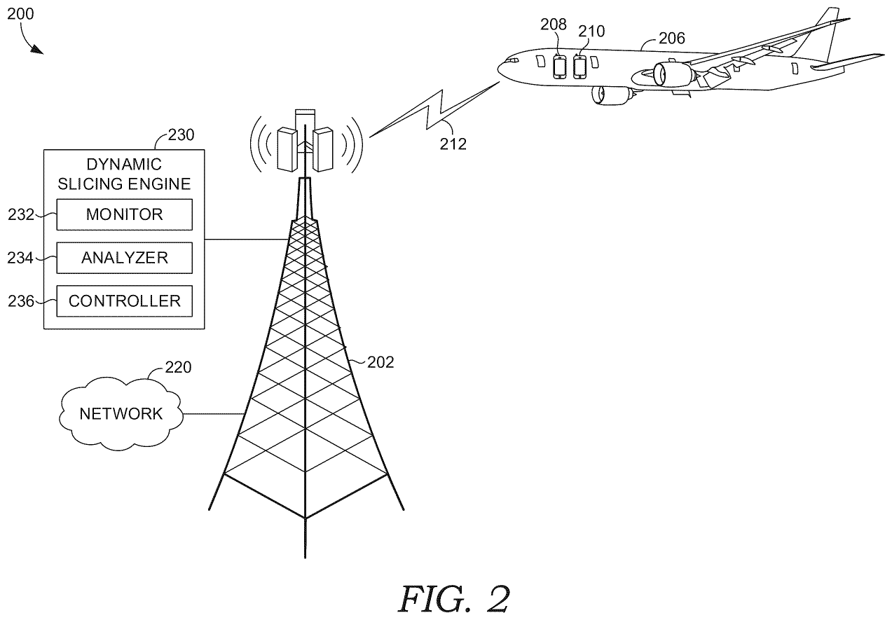

FIG. 2 illustrates an example of a network environment 200 suitable for use in implementing embodiments of the present disclosure. Such a network environment is illustrated and designated generally as network environment 200. At a high level the network environment 200 comprises a first airborne UE 208 and a second airborne UE 210 (depicted as users flying in airplane 206), one or more base stations (e.g., base station 202), one or more communication channels (e.g., airborne frequency band 212), and one or more networks (e.g., network 220). Though the airborne UEs 208 and 210 are illustrated as phones in an airplane 206, a UE suitable for implementations with the present disclosure may be any computing device, such as a drone or a connected aircraft, that is connected to a base station and is utilizing an airborne coverage area having any one or more aspects described with respect to FIG. 1. Similarly, though the base station 202 is illustrated as a macro cell on a cell tower, any scale or form of access point acting as a transceiver station for wirelessly communicating with a UE, including small cells, pico cells, and the like, are suitable for use with the present disclosure.

The base station 202 may be associated with one or more at least partially distinct networks, wherein each network is associated with one or more network identifiers. Each network may be a telecommunications network(s) (e.g., a packet data network or core network), data network, or portions thereof. A telecommunications network that at least partially comprises the network environment 200 may include additional devices or components (e.g., one or more base stations) not shown. Those devices or components may form network environments similar to what is shown in FIG. 2, and may also perform methods in accordance with the present disclosure. Components such as terminals, links, and nodes (as well as other components) may provide connectivity in various implementations. For the purposes of illustrating the present disclosure, the base station 202 may be connected to the network 220. The network 220 may include multiple networks, as well as being a network of networks, but is shown in more simple form so as to not obscure other aspects of the present disclosure.

Network slicing is a type of network functionality that logically defines one or more network resources in order to provide a certain quality of service (QOS) or make available a certain amount of network resources for certain types of devices or activities. Each slice of traffic may have its own resource requirements, QoS, security configuration, usage restrictions, and latency requirements. For example, a network slice supporting high definition streaming video has different requirements from a network slice monitoring a simple Internet of Things (IoT) device, such as a motion detector. Based on a determination that a particular UE is airborne in a first time period, the network 220 may allocate a first network slice to said UE during the first time period. Such a determination may be made by one or more components of the network, such as the base station 202 or the network 220, based on an observed characteristic or indication provided by a UE; for example, connection to airborne cells, very high rates of speed, high handovers, handovers along a flight path, GPS altitude reports from the UE, or pressure observations from the UE could be used alone or in combination to indicate that the UE is airborne.

The first network slice can be a slice exclusively allocated to airborne UEs or it could use certain existing network slices. A dedicated airborne network slice may not be usable or assigned to UEs except when they are determined to be airborne; alternatively, existing network slices, such as a network slice configured for serving UEs at a sporting event (high density of UEs), streaming devices (many UEs on an airplane typically stream video content), and non-voice UEs (priority support for voice service can impact the fidelity of non-voice service to airborne UEs) may be used.

A mobile network operator could use multiple network slices to provide for service classes (i.e., first class, economy) that could be used by airborne UEs. In other words, the first airborne UE 208 and the second airborne UE 210 may be using two different network slices when connected to the base station 202. By creating virtual partitions in network 200, this can enable tailored services to each user, such as prioritizing low-latency connections or allocating enhanced resources for data-intensive applications, thereby optimizing connectivity and performance for airborne UEs while minimizing power consumption. For example, some limitations of service might be desirable for the first airborne UE 208 (e.g., provide voice and SMS but not data), whereas the second airborne UE 210 might prefer to have more service options (e.g., provide everything but voice call, everything but video streaming, etc.). In order to provide two separate service options to the first airborne UE 208 and the second airborne UE 210, a multi-tier subscription model could be used wherein each tier can be allocated a unique network slice with unique capabilities. For example, the allocation of the first network slice may correspond to a first tier of service and may or may not require the airborne UE (e.g., 208, 210) to be subscribed to a service. In this example, the first network slice can be allocated to the first “basic” level of service (e.g., enabling the UE to access voice calls and SMS but not data). This first level of service could be prioritized for an airborne UE compared to a terrestrial UE. The allocation of a second network slice may correspond to a second tier of service and requires the airborne UE (e.g., 208, 210) to be subscribed to a service. In aspects, the second network slice is allocated to the second “premier” level of service that is more expensive and offers more features to the user (e.g., enabling the UE to access voice calls and SMS and data streaming). This second level of service could also be prioritized for an airborne UE compared to a terrestrial UE.

Once the network 220 determines that the airborne UEs 208 and 210 are no longer airborne (e.g., at the conclusion of the first time period), the network 220 may terminate the first network slice to the airborne UEs 208 and 210 at the conclusion of the first time period. In other words, when the UEs 208 and 210 are airborne they are allocated an airborne network slice and once the UEs 208 and 210 are terrestrial they are allocated a terrestrial network slice or are otherwise reverted to conventional treatment as preferred by the MNO.

The dynamic slicing engine 230 is generally performed to make and carry out dynamic slicing decisions according to one or more aspects of the present disclosure. The dynamic slicing engine 230 may be said to comprise a monitor 232, an analyzer 234, and a controller 236. The monitor 232 is generally configured to monitor requests from the one or more UEs that are requesting network resources via the base station 202. The monitor 232 is configured to process requests received by the base station 202 to determine that the requests are associated with a first network slice. For example, if a mobile network operator has assigned a first network slice for SMS, the monitor 232 may process a request from the first airborne UE 208 for SMS and determine that said request is to be processed using the first network slice. Similarly, the monitor 232 may receive a request from another airborne device such as the second airborne UE 210 and determine that said request is to be processed using a second network slice (e.g., specifically configured for devices needing low latency for video calling or data streaming). The monitor 232 may also be configured to monitor the congestion of the base station 202. In such an aspect the monitor 232 could determine congestion based on physical resource block (PRB) utilization, number of UEs connected to the base station 202, or any other metric desirable by a mobile network operator.

The analyzer 234 is generally configured to determine the utilization of the base station 202 and various network slices. In a first aspect, the analyzer 234 may be configured to inspect a UE's behavior to determine if the UE is fully utilizing a network slice; for example, whereas the monitor 232 may determine that the UE is using a video conferencing application, the analyzer 234 may determine that said UE is only utilizing one sub-service of the video conferencing application and is not using a second sub-service. In such an example, even though the UE is using a video conferencing application, the analyzer 234 may determine that only the audio stream is being used (and that the video portion is not being used/requested by the UE). In another aspect, the analyzer 234 may also be configured to determine if the congestion at the base station 202 exceeds a predetermined threshold. Exceeding the predetermined threshold may be on the basis of threshold PRB utilization, threshold high number of connected devices, or any other threshold desired by the mobile network operator.

The controller 236 is generally configured to determine that a network slicing modification trigger has occurred and to determine and cause a modification to a network slicing allocation. The network slicing modification trigger may be said to be the cause of the controller 236 making a modification to a network slicing allocation. In a first aspect, the network slicing modification trigger may comprise a determination that a congestion threshold has been exceeded at the base station 202. In such an aspect, the controller 236 may either modify the network slicing assignment for all UEs connected to the base station 202 by assigning a network slice that uses fewer network resources than that which was requested by the UEs. In another aspect, the controller 236 may modify the network slicing assignment for UEs that are not fully utilizing their requested network slice (e.g., a UE that is only using an audio sub-service of a video conferencing service and not a video sub-service). In yet other aspects, the network slicing modification trigger may be underutilization alone (i.e., without congestion). In such an aspect, the controller 236 may effectuate a change to a UE's network slice access based on the UE underutilizing that slice (e.g., only using the audio portion of a video conferencing service). In any aspect, the controller may modify the network slice assignment/access of the UE by scaling back the UE's allocated network slicing resources or by assigning the UE to a network slice that uses fewer network resources or has a reduced QOS compared to the default network slice associated with the UE's original request.

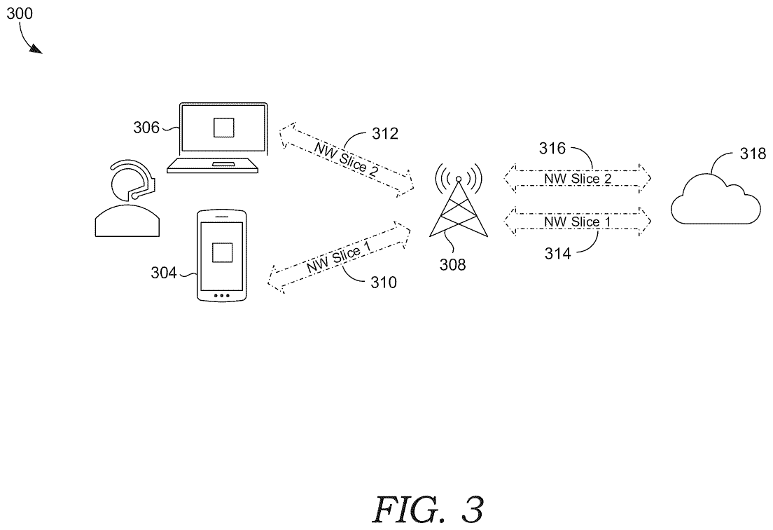

FIG. 3 depicts dynamic network slicing in a network, in which implementations of the present disclosure may be employed, in accordance with aspects herein. In a network 300, multiple devices may make similar requests to connect with a network. In accordance with one or more aspects described with respect to FIG. 2, a first UE 304 requests access to a network service 318 from a radio access network node 308, via connection 310, and a second UE 306 requests access to the network service 318 from the radio access network node 308 via connection 312. Because the first UE 304 and the second UE 306 are requesting access to the same network service 318 (e.g., tier one described above), each should be assigned a first network slice 314; however, based on a determination that a network slicing modification trigger has occurred (e.g., threshold high congestion at the radio access network node 308 or any other aspect described with respect to FIG. 2), one or more of the first UE 304 and the second UE 306 may be assigned a second network slice 316, wherein the second network slice 316 has more network resources or a higher QOS than the first network slice 314 (e.g., tier two described above).

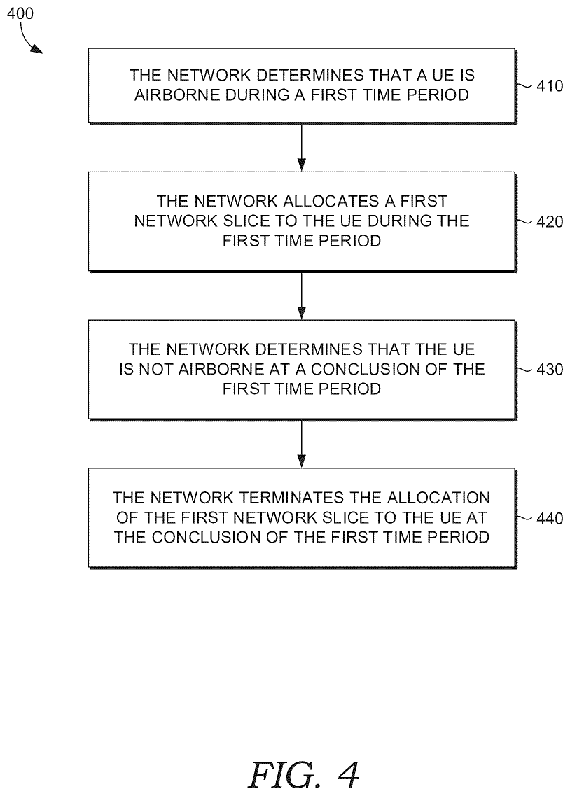

Turning now to FIG. 4, a flow chart representing a method 400 is provided. Generally the method 400 may be used by a UE, such as the airborne UEs 208 and 210 of FIG. 2, to perform targeted cell search operations. At a first step 410, the network determines that a UE is airborne during a first time period. At a second step 420, the network allocates a first network slice to the UE during the first time period. At a third step 430, the network determines that the UE is not airborne at a conclusion of the first time period. At a fourth step 440, the network terminates the allocation of the first network slice to the UE at the conclusion of the first time period.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for allocating network slices to a user equipment (UE), the method comprising:
determining that a UE is airborne during a first time period;
allocating a first network slice to the UE during the first time period;
determining that the UE is not airborne at a conclusion of the first time period; and
terminating the allocation of the first network slice to the UE at the conclusion of the first time period.

2. The method of claim 1, wherein the allocation of the first network slice is based on the UE being subscribed to a service.

3. The method of claim 2, wherein the first network slice is allocated to a first level of service.

4. The method of claim 3, wherein the first level of service is a basic level that enables the UE to access phone calls and SMS.

5. The method of claim 4, wherein the first level of service is prioritized for an airborne UE compared to a terrestrial UE.

6. The method of claim 3, further comprising a second level of service, wherein the second level of service is more expensive than the first level of service and enables the UE to access phone calls, SMS, and data streaming.

7. The method of claim 6, wherein the second level of service is prioritized for a terrestrial UE compared to an airborne UE.

8. A system for allocating network slices to a user equipment (UE), the system comprising:
one or more processors; and
one or more computer-readable media storing computer-usable instructions that, when executed by the one or more processors, cause the one or more processors to:
determine that a UE is airborne during a first time period;
allocate a first network slice to the UE during the first time period;
determine that the UE is not airborne at a conclusion of the first time period; and
terminate the allocation of the first network slice to the UE at the conclusion of the first time period.

9. The system of claim 8, wherein the allocation of the first network slice is based on the UE being subscribed to a service.

10. The system of claim 9, wherein the first network slice is allocated to a first level of service.

11. The system of claim 10, wherein the first level of service is a basic level that enables the UE to access phone calls and SMS.

12. The system of claim 11, wherein the first level of service is prioritized for an airborne UE compared to a terrestrial UE.

13. The system of claim 10, further comprising a second level of service, wherein the second level of service is more expensive than the first level of service and enables the UE to access phone calls, SMS, and data streaming.

14. The system of claim 13, wherein the second level of service is prioritized for a terrestrial UE compared to an airborne UE.

15. One or more non-transitory computer-readable media having computer-usable instructions embodied thereon that, when executed by one or more processors, cause the processors to:
determine that a UE is airborne during a first time period;
allocate a first network slice to the UE during the first time period;
determine that the UE is not airborne at a conclusion of the first time period; and
terminate the allocation of the first network slice to the UE at the conclusion of the first time period.

16. The non-transitory computer-readable media of claim 15, wherein the allocation of the first network slice is based on the UE being subscribed to a service.

17. The non-transitory computer-readable media of claim 16, wherein the first network slice is allocated to a first level of service.

18. The non-transitory computer-readable media of claim 17, wherein the first level of service is a basic level that enables the UE to access phone calls and SMS.

19. The non-transitory computer-readable media of claim 18, wherein the first level of service is prioritized for an airborne UE compared to a terrestrial UE.

20. The non-transitory computer-readable media of claim 17, further comprising a second level of service, wherein the second level of service is more expensive than the first level of service and enables the UE to access phone calls, SMS, and data streaming.
